(19) United States
(12) Patent Application Publication
(10) Pub. No.: US 2020/0082438 A1
(43) Pub. Date: Mar. 12, 2020

(54) COORDINATION SYSTEM FOR EVENTS WITH CUSTOMIZABLE ADVERTISEMENT SPACE

(71) Applicant: Outdoor Events Association, LLC, Lewes, DE (US)

(72) Inventor: Matthew R. Tunstall, Knoxville, TN (US)

(21) Appl. No.: 16/562,271

(22) Filed: Sep. 5, 2019

Related U.S. Application Data
(60) Provisional application No. 62/728,419, filed on Sep. 7, 2018.
(60) Provisional application No. 62/861,774, filed on Jun. 14, 2019.

(51) Int. Cl. G06Q 30/02

(52) U.S. Cl. CPC G06Q 30/0252; G06Q 30/0277; G06Q 30/0269; G06Q 30/0276

(57) ABSTRACT

An advertisement system coordinates advertisement placements at an event. The advertisement system receives event information related to a future event, and creates an event page based on the future event. The event page has a plurality of advertisement opportunities at the event. The advertisement system generates an advertisement selection tool that has an interactive interface for a user to select one of the advertisement opportunities. The advertisement system receives a selection of one of the advertisement opportunities and one or more product specifications associated with the selection. The advertisement system provides one or more product specifications to a fulfillment device for delivery of a product having an advertisement according to the one or more product specifications at the future event.

### CROSS-REFERENCE TO RELATED APPLICATIONS

This application claims the benefit of U.S. Provisional Application Ser. No. 62/728,419 filed Sep. 7, 2018, and 62/861,774 filed Jun. 14, 2019, both of which are incorporated herein by reference in their entirety.

### TECHNICAL FIELD

The present application relates generally to event planning and advertisement support and, more particularly, to a coordination system for events with customizable advertisement space for connecting event operators, sponsors, and advertisement suppliers.

### BACKGROUND

Advertisements are all around us in many forms. Billboards, commercials, flyers, mail, coupons, and emails are some of the more common ways that companies reach consumers. In a most basic format, an advertisement is simply a message that is capable of being viewed or heard by a potential customer. Advertisements, and particularly space for advertisements, is often a significant portion of funding collected by an operator in a position to deliver the ads to consumers. For example, a content provider, such as a television network or radio station, will often subsidize their product by selling ads that become a part of the product. This concept extends to events, such as concerts, festivals, construction sites, sporting events, multicultural events, health and fitness event, etc., that may place advertisements in and around their venue as a way to fund the event.

While some organizations have the means and opportunity to manage the coordination and support of their advertisement structure, there is not a universal tool that can be used by event operators, sponsors, and suppliers alike in order to coordinate and ultimately deliver the advertisements in an easy and efficient manner that is beneficial to all parties. The present disclosure is directed to overcoming this and other problems of the prior art.

### SUMMARY

In some embodiments, the present disclosure describes a computer-implemented method for coordinating advertisement placements at an event. The method includes receiving event information related to a future event, and creating an event page based on the future event, the event page including a plurality of advertisement opportunities at the event. The method further includes generating an advertisement selection tool, the advertisement selection tool being an interactive interface for a user to select one of the advertisements. The method also includes receiving a selection of one of the advertisement opportunities through the advertisement selection tool, and receiving one or more product specifications associated with the selection. The method further includes providing one or more product specifications to a fulfillment device for delivery of a product having an advertisement according to the one or more product specifications at the future event.

In other embodiments, the present disclosure describes an advertisement system for coordinating advertisements at an event. The advertisement system includes a coordination device configured to communicate with a client device to provide a user interface to the client device. The advertisement system includes a login module, a sponsor module, an event coordination module, and an advertisement supply module. The login module is configured to create, secure, and store user profiles associated with a plurality of users. The sponsor module is configured to provide a customization tool to the client device for receiving advertisement details from a user. The event coordination module is configured to create an advertisement selection tool based on information associated with an event and provide the advertisement selection tool to the client device. The advertisement supply module is configured to coordinate delivery of an advertisement based on the advertisement details and a selection received through the advertisement selection tool.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a block diagram of one embodiment of an advertising system, consistent with disclosed embodiments;

FIG. 2 depicts a block diagram of an example client device, consistent with disclosed embodiments;

FIG. 3 depicts a block diagram of an example client device, consistent with disclosed embodiments;

FIG. 4 is a flowchart of an exemplary event creation process, consistent with disclosed embodiments;

FIG. 5 is an exemplary user interface of an event page, consistent with disclosed embodiments;

FIG. 6A is an exemplary user interface of an advertisement selection tool, consistent with disclosed embodiments;

FIG. 6B is another exemplary user interface of an advertisement selection tool, consistent with disclosed embodiments;

FIG. 6C is another exemplary user interface of an advertisement selection tool, consistent with disclosed embodiments;

FIG. 7 is a flowchart of an exemplary advertisement agreement process, consistent with disclosed embodiments;

FIG. 8A is an exemplary user interface of an advertisement customization page, consistent with disclosed embodiments;

FIG. 8B is a first exemplary user interface of an event operator review page, consistent with disclosed embodiments;

FIG. 8C is a second exemplary user interface of an event operator review page, consistent with disclosed embodiments;

FIG. 9 is a flowchart of an exemplary advertisement fulfillment process, consistent with disclosed embodiments;

FIG. 10 is a block diagram of an exemplary event device, consistent with disclosed embodiments; and

FIG. 11 is a flowchart of an exemplary media content display process, consistent with disclosed embodiments.

### DETAILED DESCRIPTION OF EXEMPLARY EMBODIMENTS

The present disclosure describes an advertising system that connects different parties associated with delivering an advertisement to a potential customer at an event. In an exemplary embodiment, the system may be used by an event operator to connect to an advertisement supplier, such as a portable restroom operator having the ability to customize a surface of a portable restroom with an advertisement, and a sponsor, such as a company willing to pay for their chosen advertisement to appear on the customizable surface during the event. The all-in-one system is configured to provide different experiences and incentives for the various parties. For example, the event operator is able to receive funding through the system by agreeing to place the advertisements within the event. An advertisement supplier is able to gain business for their product, whether it be a portable restroom or other element that serves as the object for displaying the advertisement. Further, sponsors are able to use the system as a means to place an advertisement.

In an exemplary embodiment, the advertising system may be implemented through a back-end server that hosts or connects a website to a client device. Users operate their own client device, such as a personal computer or mobile device, to connect to the system and gain access to the tools that are relevant to their needs. For example, the website may include different elements for different users. An advertisement supplier may be able to view a list of events that are available for their services as well as a list of sponsors that are already connected to an event. An event operator may see a list of potential sponsors and review and select those that they are willing to place within their events. The event operator can also work through the system to coordinate placement of the advertisements within the event. Potential sponsors can review advertisement opportunities, customize the actual advertisement to be placed, and work with the supplier to ensure proper delivery.

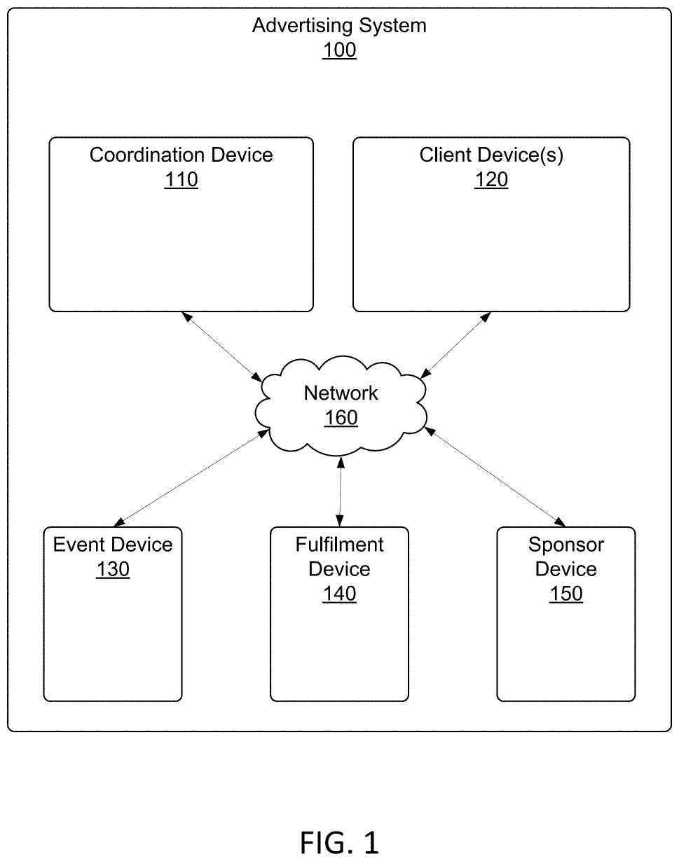

FIG. 1 depicts a block diagram of one illustrative embodiment of an advertising system 100. The advertising system 100 includes, for example, a coordination device 110, a client device 120, an event device 130, a fulfillment device 140, and a sponsor device 150 connected through a network 160. The coordination device 110, client device 120, event device 130, fulfillment device 140, and sponsor device 150 are functionally represented as singular separate components but it should be understood that the disclosed embodiments are not so limited. The devices may be combined in some embodiments. In accordance with some exemplary embodiments, the elements of the advertisement system 100 include logic implemented in specialized hardware, software executed on hardware, or any combination of specialized hardware and software executed on hardware, for implementing the advertising system 100.

The coordination device 110 may be implemented in hardware and/or software and may include various constituent components. These components may include, for example, one or more processing devices, one or more memory devices, and/or one or more databases. The coordination device is particularly configured as an information hub which is configured to receive data from the client devices 120, event devices 130, fulfillment devices 140, and/or sponsor devices 150. For example, the coordination device 110 may be configured as a back-end server that hosts a website for coordinating advertisement agreements between an advertisement supplier, an event coordinator, and an advertisement sponsor. In an embodiment, the coordination device 110 is a server, but is not limited to such an embodiment.

The client devices 120 are preferably computing devices configured to access the website managed by the coordination device 110. The client devices 120 may be, for example, personal computers (e.g., laptops, desktops, etc.), tablets, smart phones, etc. The client devices 120 may include constituent components. These components may include, for example, processing and memory components, communication hardware for sending and receiving data to and from other components of the advertising system 100, a display device for displaying information to a user, such as a display screen configured to display a user interface, and an input device for receiving user input, such as a keyboard or touch screen capability. The client device 120 may be operated by different types of users. For example, one user may be an event coordinator, another user may be an advertisement supplier, and a third user may be a representative of a sponsor or potential sponsor. In some embodiments, one or more of the event device 130, fulfillment device 140, and sponsor device 150 may be a client device 120.

The event device 130 is preferably a computing device configured to communicate with the other components of the advertising system 100 in order to provide information related to an event, perform an action related to the event, etc. In one example, the event device 130 is a computing system, such as a server or personal computer, managed by an event coordinator and configured to track the location of advertisements throughout an event location. In another example, the event device 130 may be a physical device at the event that is capable of displaying the advertisement, such as an electronic screen or billboard.

The fulfillment device 140 is preferably a computing device configured to communicate with the other components of the advertising system 100 in order to complete the delivery of an advertisement. In one example, the fulfillment device 140 is a computing system, such as a server or personal computer, managed by an advertisement supplier and configured to receive a customized advertisement order and submit an advertisement. In one example, the fulfillment device 140 is connected to a printer and is configured to print a selected advertisement. In another example, the fulfillment device 140 is an inventory tracking device that coordinates the customization, delivery, and return of advertisements and the products that include the advertisements, such as billboards, portable restrooms, etc.

In some embodiments, the fulfillment device 140 is a connection between an event device 130 and sponsor device 150 to enable the sponsor device 150 to deliver an advertisement to a customizable platform, such as a video screen mounted to a portable restroom facility. For example, the fulfillment device 140 may be an FTP connection therebetween. In some embodiments, the fulfillment device 140 may be a content management system configured to collect advertisements from sponsor devices 150 and selectively deliver them to an event device 130.

The fulfillment device 140 (or other element of the system 100) may be configured to perform one or more processes (e.g., analytics) to determine which advertisements to deliver to an event device 130. For example, the fulfillment device 140 may use input data (e.g., information about people in the area of an event device 130) to determine which advertisement to deliver to an event device 130 (e.g., in the case of the event device 130 including an electronic screen).

The sponsor device 150 is preferably a computing device configured to communicate with the other components of the advertising system 100 in order to communicate with a sponsor user and receive sponsor-related data. In one example, the sponsor device 150 is a computing system, such as a personal computer, mobile device, or server, managed by a sponsor or potential sponsor and configured to provide multimedia content to be included in an advertisement. The sponsor device 150 may include an audio and/or video capturing device configured to supply multimedia content to the coordination device 110 for use in an advertisement. In some embodiments, the sponsor device 150 may be a content management system configured to selectively deliver advertisements to the event device 130 (e.g., instead of or in addition to the fulfillment device 140 being a content management system).

The network 160 may be a local or global network and may include wired and/or wireless components and functionality which enable communication between the coordination device 110, client devices 120, event devices 130, fulfillment devices 140, and sponsor devices 150. The network 160 may be embodied by the Internet, provided at least in part via cloud services, and/or may include one or more communication devices or systems which enable data transfer to and from the systems and components of the advertisement system 100.

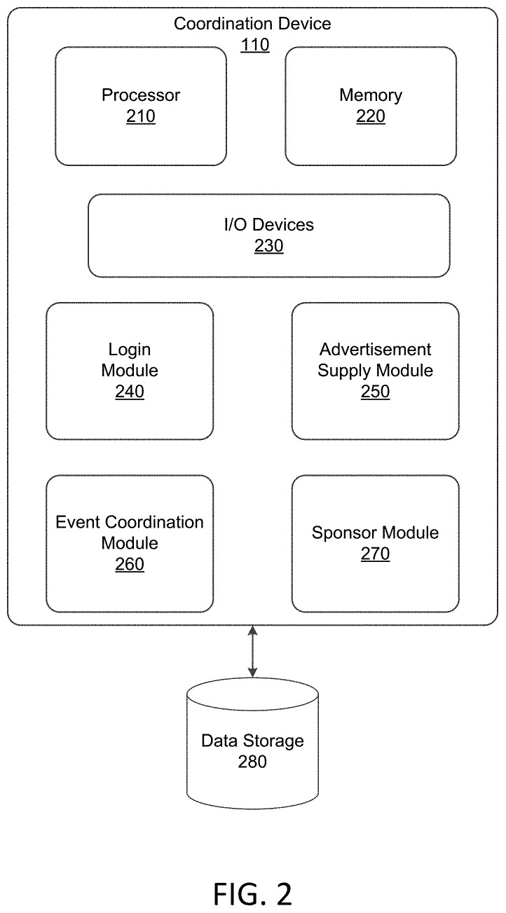

FIG. 2 is a block diagram of an exemplary embodiment of the coordination device 110. The coordination device 110 includes a processor 210, memory 220, one or more I/O devices 230, one or more control modules 240-270, and a data storage device 280. The processor 210 and memory 220 may be specifically configured to implement the disclosed processes. The I/O device 230 may include, for example, communication components which enable the coordination device 110 to send and receive data to and from other components of the advertising system 100.

The control modules 240-270 may include, for example, a login module 240, a advertisement supply module 250, an event coordination module 260, and a sponsor module 270. The control modules 240-270 may be implemented in hardware or software. For example, the control modules 240-270 may include software instructions which are stored in the memory 220 or in their own hardware component and which are executed by the processor 210 in order to carry out an associated process. The control modules 240-270 are exemplary and other control modules may be used in addition to or in place of the control modules described herein.

The login module 240 is configured to monitor and authenticate login attempts from a client device 120 to the coordination device 110. The coordination device 110 may store user profile with login information such that the login module 240 controls when requests are received from a client device 120. The user profiles may be stored, for example, in the data storage device 280. In an exemplary embodiment, the login module 240 is configured to differentiate between different types of user profiles. A first type of user profile may include an advertisement supplier profile (e.g., a portable restroom operator). A second type of user profile may include an event operator profile (e.g., the management entity for a festival or concert or construction site). A third type of user profile may include a sponsor profile (e.g., a company that is seeking to place advertisements at an event). While these user profiles are described, it should be understood that the disclosed embodiments are not so limited. For example, other users may include performer users (e.g., musicians, actors, comedians, etc.) that have access to the communication channels established by the advertisement system 100, such as to apply and/or contract with event operators to perform at an event.

The login module 240 is configured to classify a user profile and control features that are available to the different types of users. In some embodiments, the login module 240 may create a list of permitted users. The list of permitted users may represent users (e.g., through identifying information) that have been invited to create a user profile. For example, in some embodiments, an advertisement supplier may only create a user profile after signing an agreement with an event operator and being invited to join. In other embodiments, event operators may invite advertisement suppliers and sponsors and/or sponsors may invite event operators and advertisement suppliers. The particular configuration of managing the creation of user profiles is not limited and can be customized to the particular needs of the system 100.

The advertisement supply module 250 is configured to control communication with the event device 130, fulfillment device 140, and sponsor device 150 in order to coordinate advertisement order fulfillment. For example, the advertisement supply module 250 may communicate advertisement parameters to and receive advertisement selections from sponsor devices 150 in order to produce a contracted advertisement according to desired specifications. The advertisement supply module 250 may track advertisement parameters to ensure that each fulfilled order satisfies the parameters. For example, the advertisement supply module 250 may track a list of excluded advertisements (e.g., content, sponsors, etc.) and notify the event device 130 and/or fulfillment device 140. The advertisement supply module 250 may further track advertisements after they have been placed and provide updates to relevant users, such as sponsors.

In some embodiments, the advertisement supply module 250 is part of a content management system configured to provide advertisements to an event device 130 that includes a digital screen, audio speakers, or billboard. The advertisement supply module 250 may coordinate a playlist of changing advertisements for each display of one or more event devices 130.

The event coordination module 260 is configured to further control communication between the event device 130, fulfillment device 140, and sponsor device 150. For example, the event coordination module 260 may track available advertisement locations and place newly selected advertisements as applicable. The event coordination module 260 may receive a site map from an event device 130 and convert the map into a visual representation of the available and unavailable advertisement locations. The event coordination module 260 may provide the visual representation to users through the website.

The sponsor module 270 is configured to track sponsors and create sponsor lists that are available to various users. For example, the sponsor module 270 may collect a list of potential sponsors for review by an event coordinator user. The sponsor module 270 may further track already-contracted sponsors for a particular event and provide the list to other users, such as advertisement supply users and/or other sponsors. The sponsor module 270 may also coordinate payment from the sponsor users for the advertisements.

In an exemplary embodiment, the login module 240, advertisement supply module 250, event coordination module 260, and sponsor module 270 may work in conjunction with each other, such as by executing stored instructions through the processor 210, to coordinate the delivery of an advertisement to an event. For example, the login module 240 may create and store user profiles associated with a plurality of users, including an advertisement supplier user, an event operator user, and a sponsor user. The sponsor module 270 may provide a customization tool to the client device 120 for receiving advertisement details from a user. These advertisement details may include the content of a proposed advertisement. The content may be submitted to the event device 130 as an event proposal, thereby allowing an event operator to approve, modify, or decline the proposal. The event coordination module 260 may create an advertisement selection tool based on information associated with an event and provide the advertisement selection tool to the client device 120. The advertisement selection tool may include, for example, a map of available advertisement locations. The advertisement supply module 250 may coordinate delivery of an advertisement based on the advertisement details received by the sponsor module 270 and a selection received through the advertisement selection tool by the event coordination module 260.

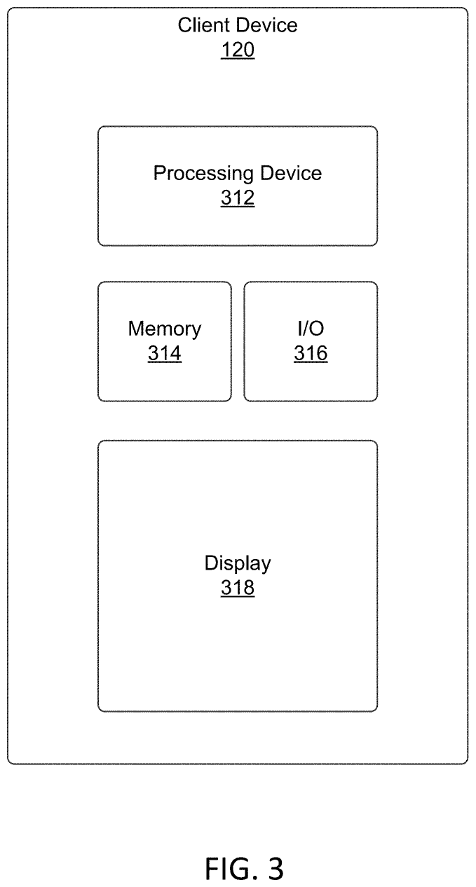

FIG. 3 is a block diagram of an exemplary embodiment of a client device 120. The client device 120 includes a processing device 312, memory 314, I/O 316, and display 318. The processing device 312 is configured to execute instructions from the memory 314 in order to perform one or more processes associated with providing advertisement services through connection to the coordination device 110. The client device 120, in an exemplary embodiment, is a device operated by a user, such as an advertisement supply user, an event operator user, or a sponsor user. The user is preferably associated with a user profile stored by the coordination device 110. The client device may be, for example, a laptop, desktop computer, mobile device (e.g., smart phone, tablet, etc.), or other computing device accessible by a user. The I/O 316 may include the display 318 which is configured to display a user interface, such as a user interface associated with a website managed by the coordination device 110.

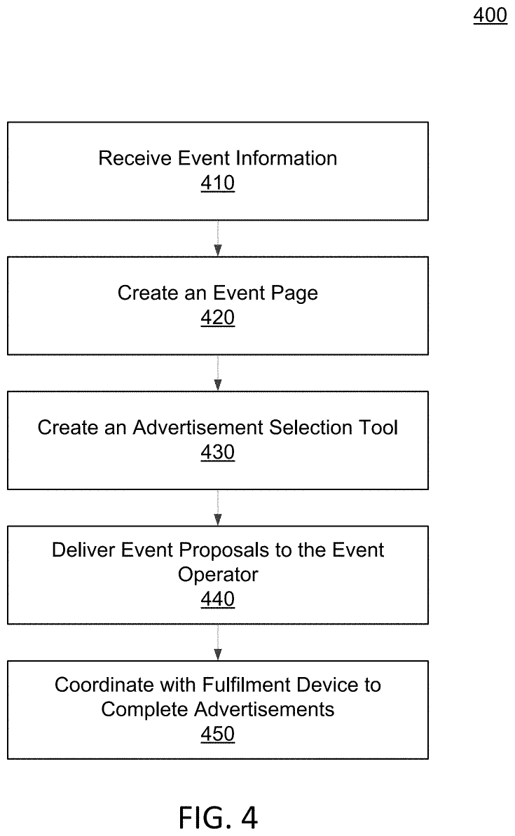

FIG. 4 is a flowchart of an exemplary process 400 for establishing an event with available advertisement opportunities through the coordination device 110. The event page is associated with an event, such as a festival, concert, sporting event, construction site, multicultural event, or health and fitness event, etc. In an exemplary embodiment, the event is an outdoor event that will include portable restrooms, however, all embodiments are not limited to these events. The portable restrooms of the outdoor event are examples of advertisement spaces, but it should be understood that other advertisement schemes may be implemented that may be covered by disclosed embodiments. For example, an outdoor or indoor event may coordinate billboard advertisements through coordination device 110.

The coordination device 110 may perform one or more steps of the process 400, but the embodiments are not so limited. Other components of the advertising system 100 may perform one or more steps of any of the disclosed processes, including the process 400.

In step 410, the coordination device 110 receives event information. For example, the coordination device 110 may receive information from a client device 120 and/or an event device 130 (which may be the same device). The information may include an event profile that the coordination device 110 may store in the data storage device 280. The event profile information may include identifying information for the event, such as event details, date, times, pictures, names, demographics, associated entities, vehicle traffic counts, etc. The information may further include details regarding available advertisement opportunities.

In step 420, using the event information, the coordination device 110 may create an event page that is displayable through a user interface to some users. In this way, advertisement supply users and sponsors can view upcoming events. The event page may be a webpage that is managed by the coordination device 110 and accessible by authenticated users.

In step 430, the coordination device 110 further creates an advertisement selection tool. The advertisement selection tool is an interactive tool that provides available opportunities of advertisements at the associated event. In one embodiment, the advertisement selection tool is a map of portable restrooms at the event. The advertisement selection tool may include a selectable element that allows a sponsor user to select a specific advertisement location (e.g., a specific portable restroom unit) for providing an advertisement option to the user. In some embodiments, the advertisement selection tool may allow a sponsor to purchase time for advertisements on video screens associated with event device 130.

In step 440, in at least some embodiments the coordination device 110 delivers event proposals to the event operator (e.g., the event device 130 or a client device 120 associated with an event operator). The event proposals include sponsor applications for advertisements at an event. The applications may include sponsor details (e.g., company name, contact information, industry, etc.) and advertisement details (graphics, type of advertisement, size, etc.). The event proposals allow the event operators to create a list of approved sponsors.

In step 450, the coordination device 110 coordinates with the fulfillment device 140 in order to complete advertisement orders for the event. For example, the coordination device 110 tracks changes made via the advertisement selection tool by approved sponsors and event operators and provides updates to advertisement suppliers in order to coordinate the creation and delivery of advertisement products, such as portable restrooms with surfaces modified to include selected advertisements.

The process 400 is a general process that provides for the establishment of an event and the availability of an advertisement selection tool that provides the functionality of customizing advertisement products based on selections made by sponsors (with event operator approval). The coordination device 110, in some embodiments, may provide the tools associated with the process 400 to a user that is logged into the system with an event operator user profile. For example, the event operator user's client device 120 may receive access to an event creation page, including space for providing event information. In some embodiments, the event operator user may upload a site map via their client device. The site map may include locations for advertisements (e.g., locations for portable restrooms, toilet trailers, shower trailers, tents, stages, chairs, jumbotrons, LED tvs, etc.). The coordination device 110 may create the advertisement selection tool from the site map. The event operator user access may also include information about potential sponsors and an ability to select sponsors for the event, as will be described further herein.

In some embodiments, the advertisement supplier (e.g., portable restroom operator) may invite event operators to add events through process 400. For example, an advertisement supplier with a user profile managed by the login module 240 may have the option to invite clients (e.g., event operator clients) to add their events to the website managed by the coordination device 110. In some embodiments, event operators may invite advertisement suppliers to connect an associated fulfillment device 140 to the system 100 and deliver advertisements to associated events through the disclosed systems and methods.

Invitations to various users may be controlled through an invitation system or module within the advertising system 100 (e.g., the invitation system may be a component of the coordination device 110). The invitation system may create a store a list of permitted users, registered users, invited users, active users, etc. In some embodiments, the invitation system may include an API to integrate with a user's system (e.g., event device 130, fulfillment device 140, and/or sponsor device 150), such as an advertisement supplier or event operator's customer relations management system. In some embodiments, the invitation system may receive data from a user platform associated with the customer relations management system, via the API, and automatically invite all users entered into the user platform.

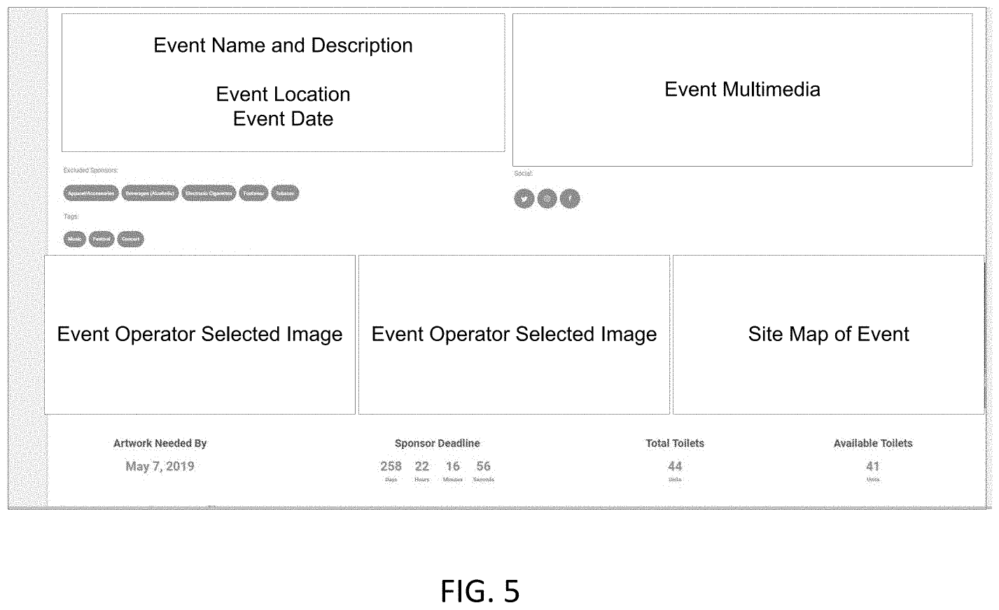

FIG. 5 is an example of a user interface depicting an event page that is created by the coordination device 110 after receiving event information. The client device 120 may display the event page to a user through the display 318. The event page includes the event information, including an event map. In some instances, the event page further includes information about advertisement opportunities, such as deadlines and availability. For instance, the event page may provide a deadline for uploading the an event proposal (e.g., the artwork of the advertisement), a number of total portable restrooms that will be placed at the event, an indication of desired and/or excluded advertisement types, content, or advertisers, metatags for use in searching and filtering, and an indication of a number of portable restrooms still available for selection and placement of an advertisement.

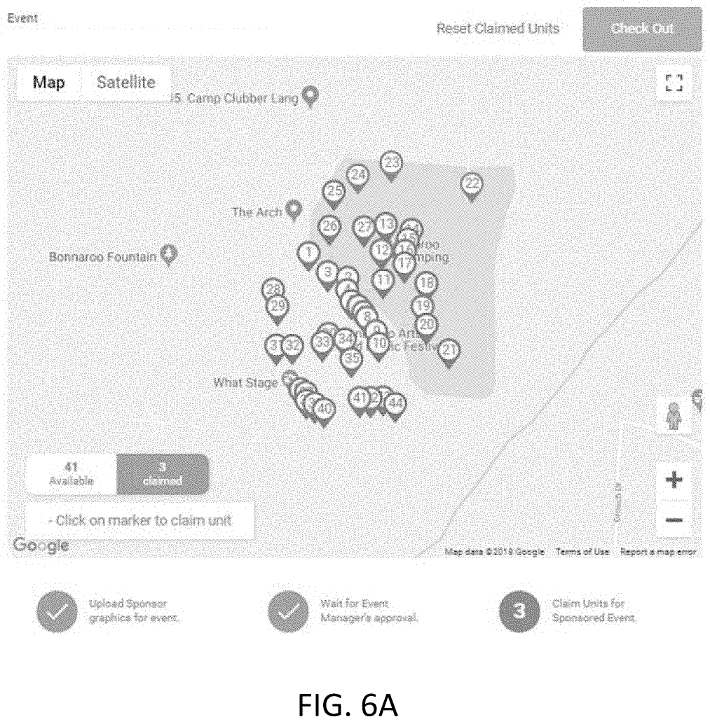

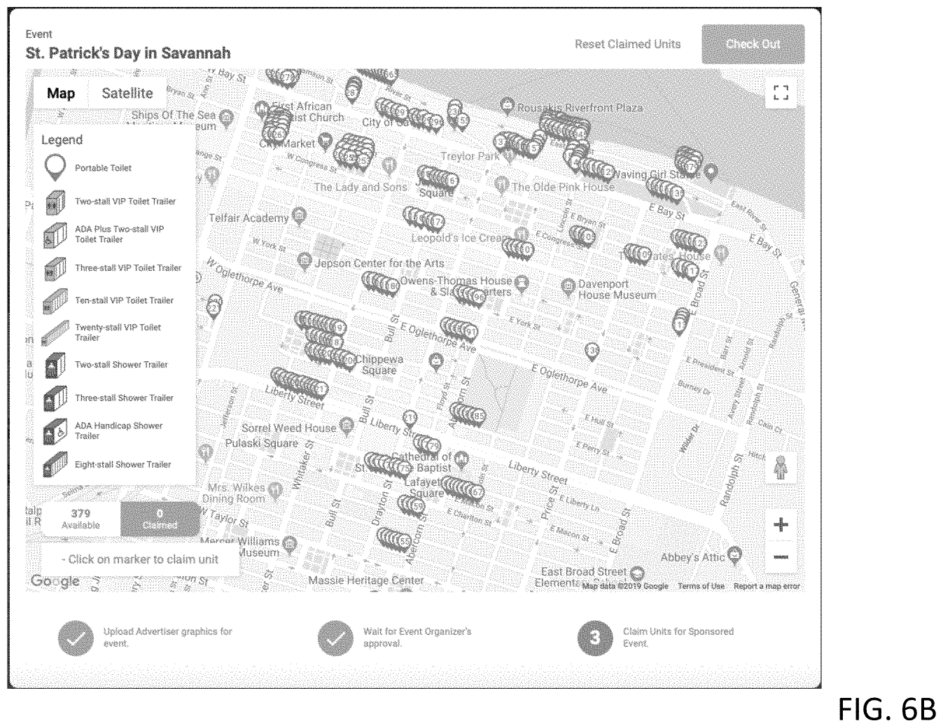

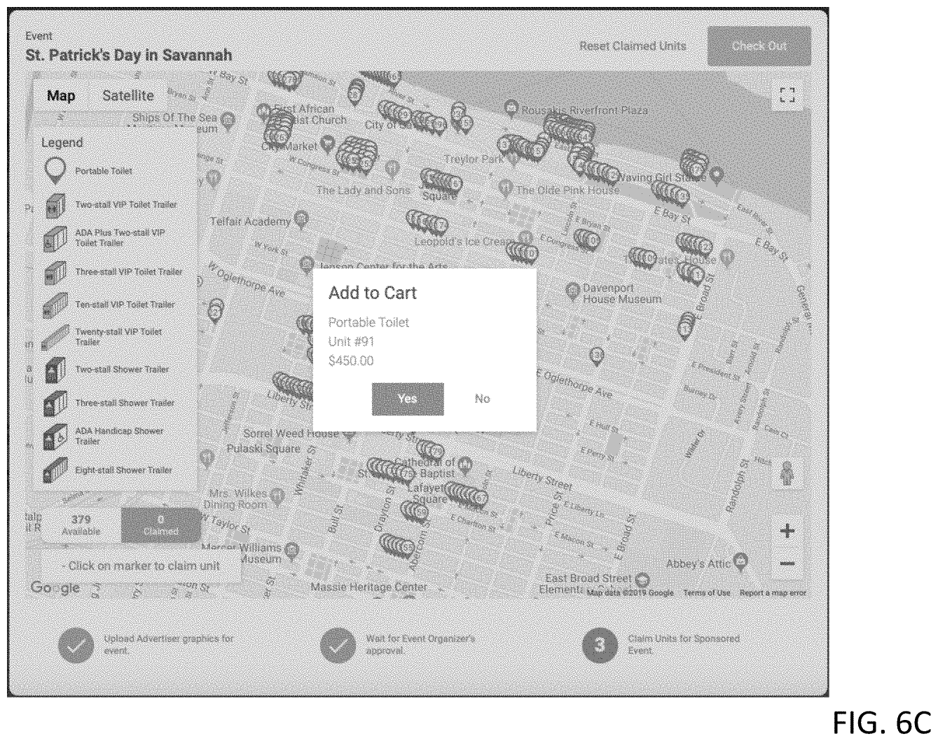

FIG. 6A is an example of a user interface depicting an advertisement selection tool. The advertisement selection tool may include a map with a plurality or markers indicating advertisement locations and/or advertisement types. The markers may be numbered and selectable to receive additional information, such as size, pricing, nearby event features, etc. The advertisement selection tool may also indicate whether the marker represents an available advertisement location or an unavailable advertisement location. In some embodiments, the advertisement selection tool may provide information about sponsors associated with unavailable advertisement locations. Each marker may also indicate the type of advertisement that can be placed at that location. For instance, the marker may indicate that the advertisement will be presented on a side of a portable restroom, on a video screen in a Toilet Trailer, on a billboard, on a Jumbotron, etc.

In some embodiments, the advertisement selection tool may include additional tools that are presented upon selection of a marker. For example, each marker may be associated with an additional tool that relates to the type of advertisement. For instance, a marker associated with a video screen may prompt a user to select media (e.g., photos, video, etc.) and place the content into a playlist for location and event associated with the selected marker.

FIG. 6B is another example of a user interface depicting an advertisement selection tool. This user interface may include different indicators for different types of advertisement locations, such as different portable restrooms. FIG. 6C is another example of a user interface, depicting a process for selecting an advertisement location for placement of an advertisement (e.g., at an event).

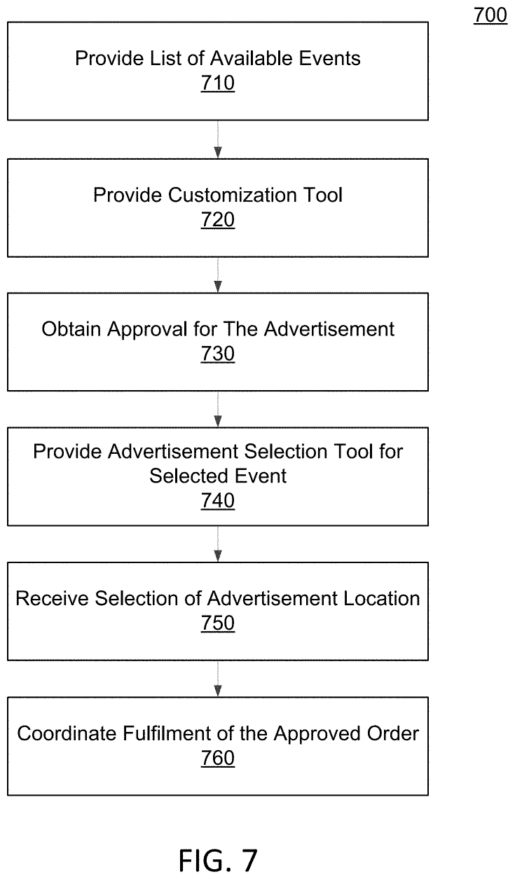

FIG. 7 is a flowchart of an exemplary process 700 for a sponsor to place an advertisement at an event. The coordination device 110 may perform one or more steps of the process 700 in order to allow a sponsor user to select and/or apply for an advertisement placement at an event. The coordination device 110 may control, through the login module 240, the creation of a sponsor user profile, enabling a sponsor user to access the system and leading to the coordination device performing the process 700.

In step 710, the coordination device 110 provides a list of available events. For example, the coordination device 110 may list event profiles through a user interface and provide that information through the website for display by a user interface of the client device 120. The list of available events may include event information and available advertisement opportunities. Each event may be selectable in order to be directed to an event page, such as an event page created in process 400.

In some embodiments, the events available to a sponsor may be filtered based on event details and preferences provided by an event operator. For example, an event operator may provide advertisement parameters, such as industry categories, content, type of advertiser, etc., that are allowed or excluded from the event. In some embodiments, the event operator (e.g., the event device 130) may provide information such as attendee demographics, traffic counts, foot traffic, etc. to further define the advertisement opportunity. Further, in some embodiments, the event device 130 may return real-time data (vehicle or foot traffic information, facial recognition data, etc.) that further allows the coordination device 110 to represent the available advertisement space and customize the content. The coordination device 110 may receive sponsor details (e.g., the sponsor's industry category), compare the sponsor details to the advertisement parameters, and create a list of events for which the sponsor is eligible to apply.

In step 720, the coordination device 110 provides a customization tool to the client device 120. The client device 120 displays the customization tool, which allows the sponsor user to provide information about the desired advertisement. For example, the customization tool may provide a variety of advertisement style options, as well as a picture uploading feature for the advertisement or a picture selection feature for selection among stored options. In some embodiments, the customization tool may include a variety of advertisement type options for supplying content, such as still picture advertisements, videos for display screens, interactive content, etc. In some embodiments, the customization tool may provide sponsors with an option to crowd-source the content of a submission and/or use an automatic advertisement generator tool. The client device 120 submits information received through the customization tool to the coordination device as part of an event proposal.

In step 730, the coordination device 110 may obtain approval for the advertisement. For example, the coordination device 110 may provide an event operator user, through their user profile, with a list of event proposals submitted by sponsors. The coordination device 110 may provide the details of the sponsor (e.g., the name of the company, their profile, products sold, etc.), their desired customization of the advertisement (e.g., the picture or artwork to be displayed), and the like. The event operator user may, through operation of a client device 120 and/or event device 130, provide approval for selected advertisement applications based on their parameters for allowing advertisements at the event.

In step 740, the coordination device 110 provides an advertisement selection tool for a selected event to a client device 120. The advertisement selection tool, such as the one shown as an example in FIG. 6, is an interactive interface displayed through the client device 120 such that the sponsor user can view and select advertisement opportunities at the selected event. For example, the coordination device 110 may provide a list of available advertisement locations, including information about the locations, including pricing and/or size and any restrictions on the advertisement.

In step 750, the coordination device 110 receives a selection of an advertisement location. For example, the sponsor user may provide a selection to a client device 120 through the advertisement selection tool. The selection may include a desired location for an advertisement at the selected event, content of the advertisement (e.g., selected from content submitted in approved event proposals), timing of the advertisement, etc.

In step 760, the coordination device 110 may coordinate fulfillment of approved advertisement orders. For example the coordination device 110 may gather information about an approved order, such as the advertisement information collected in previous steps and processes, and provide the information to an advertisement supply user, such as a user associated with a fulfillment device 140. The advertisement supply user may be, as described herein, a portable restroom operator, tent rental company, fencing rental company, barrier rental company, stage rental company, etc. The advertisement supplier may receive approved orders at the fulfillment device 140 and perform a fulfillment process in order to deliver the advertisement product, with the customized advertisement, to the event site.

In some embodiments, the fulfillment device 140 may be associated with a fulfillment user, such as a project manager or advertisement installer that assists with or performs on-site installations of advertisements. A fulfillment device 140 associated with a fulfillment user of this type may receive a notification from the coordination device 110 once a transaction has been completed by a sponsor user. This allows the fulfillment user to perform desired tasks, such as coordinate the printing, shipping, and installation of the advertisement.

In some alternative embodiments, the steps of the process 700 may be modified to allow multiple users apply for advertisement services. For example, multiple sponsors may apply or “bid” for advertisement locations using an advertisement selection tool. The bid may include advertisement parameters such as content and type of advertisement, desired size and/or location of the advertisement, as well as one or more delivery parameters (e.g., price, timing, etc.). The coordination device 110 may provide the bids to an event operator user (e.g., to an event device 130) and the event operator may select sponsors for placing advertisements. In other embodiments, the coordination device 110 may perform an automated process to select a winning bid based on a variety of factors selected by the event operator. In another example, multiple advertisement suppliers may apply or “bid” to provide services to an event, such as delivery and placement of portable restrooms with advertisements.

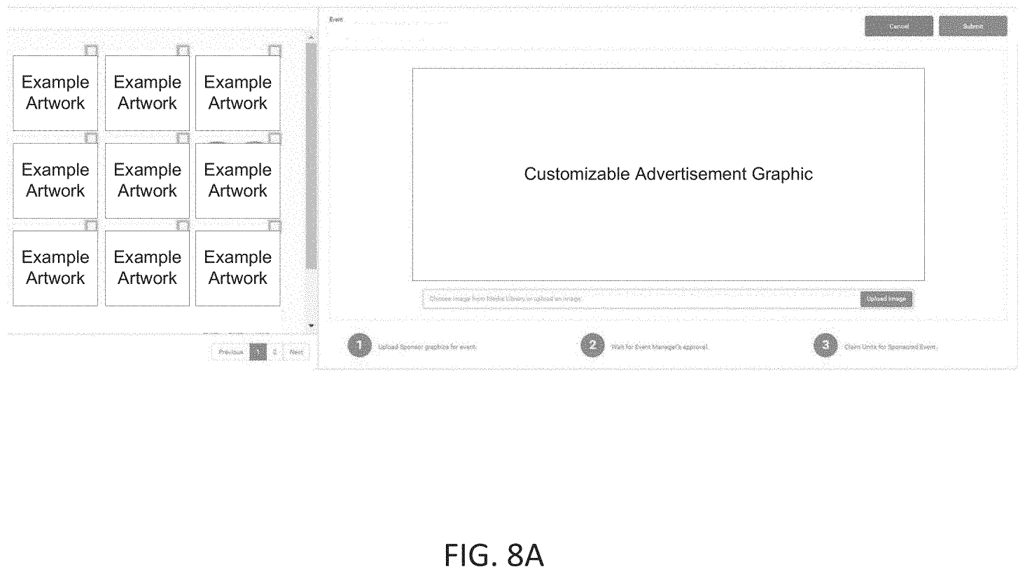

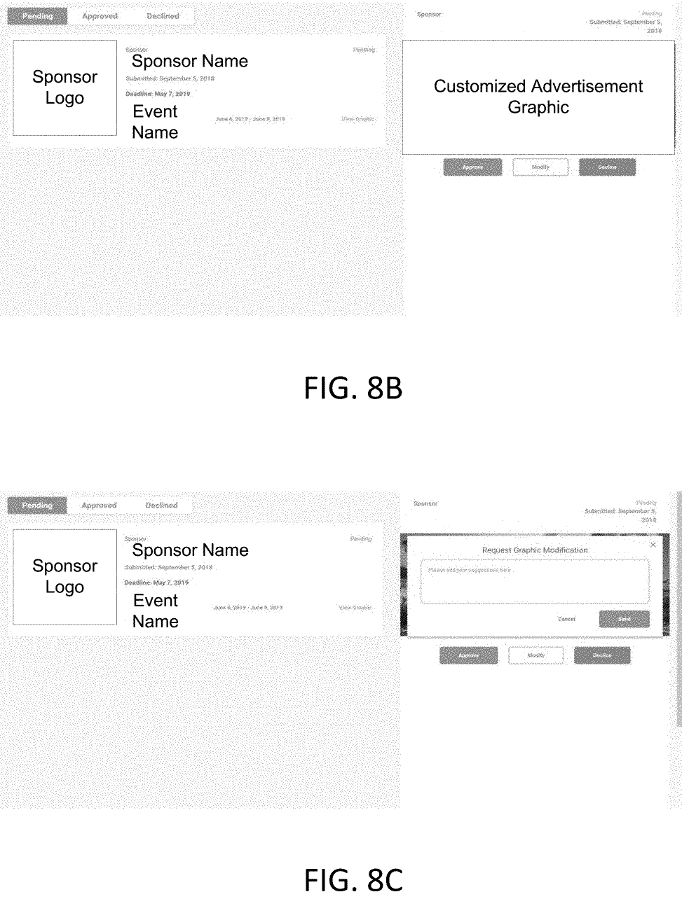

FIG. 8A is an example of a user interface depicting a customization tool for allowing sponsor users to submit event proposals. The customization tool provides a sponsor user, through their client device 120, with options for customizing their desired advertisement. The customization tool may include a picture or video upload and/or selection tool that allows the user to provide, through the client device 120, a desired image that will be the advertisement. The customization tool may further include an image preview section that previews the customized advertisement.

FIGS. 8B and 8C are examples of user interfaces depicting event operator review pages that may be presented to an event operator. In FIG. 8B, a customized advertisement graphic (e.g., a graphic submitted for review by a sponsor user using the customization tool of FIG. 8A) is displayed. The event operator user has the option to approve, modify, or decline the proposal. FIG. 8C includes a graphic modification tool that allows the event operator user to provide comments or suggestions to the sponsor for modifying the graphic. The coordination device 110 tracks approved and declined event proposals. If approved, the coordination device 110 allows the sponsor user to select an advertisement location using the advertisement selection tool.

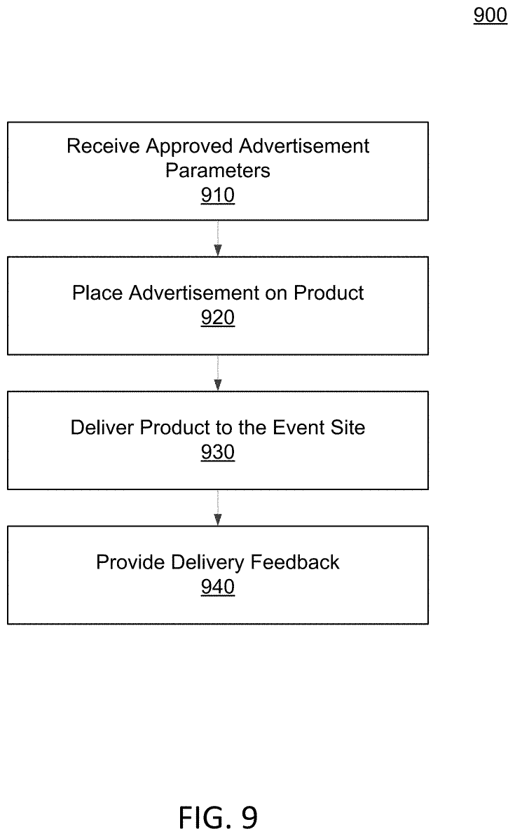

FIG. 9. is a flowchart of an exemplary process 900 for fulfilling an advertisement order after submission by a sponsor and, in some embodiments, approval by the event operator. In one embodiment, the fulfillment device 140 may perform one or more steps of the process 900 in order to allow the advertisement supplier to follow through with the delivery of a customized advertisement product, such as a portable restroom that has been modified to display a selected advertisement.

In step 910, the coordination device 110 provides the approved advertisement parameters to the fulfillment device 140. For example, the coordination device 110 may provide at least an image and one or more product specifications for the approved advertisement. The one or more product specifications may include, for example, the style, size, and/or location of the advertisement on the product. In the example of a portable restroom, the product specifications may include the size and shape of the printed material that will cover a surface of the portable restroom, as well as the location on the portable restroom that will display the material. The fulfillment device 140 may receive these parameters through the website and/or through another communication channel established with the coordination device 110.

In step 920, the fulfillment device 140 coordinates placement of the advertisement on the product. For example, the fulfillment device 140 may provide the image and one or more product specifications to a designated printer through an FTP server (e.g., the coordination device 110 communicating with the fulfillment device 140). The fulfillment device 140 operates the printer in order to create the advertisement sheet, which is applied to the product, either through an automated or manual application process. The result is a product (e.g., a portable restroom) with the customized advertisement.

In step 930, the fulfillment device 140 provides necessary information to ensure delivery of the product to the event site. For example, the fulfillment device 140 may create a delivery slip that is provided to a user. The delivery slip may indicate the event and the location within the event for the associated product. For instance, the fulfillment device may provide delivery information to a portable restroom operator such that the operator can correctly place the portable restroom in the selected location (e.g., the location selected by the sponsor) at the event site.

In step 940, the fulfillment device 140 may provide delivery feedback to the sponsor and/or the event coordinator. For example, the fulfillment device 140 may receive a picture of the placed advertisement at the event. The user that delivers the advertisement product (e.g., portable restroom) may capture a picture with their smartphone and provide the picture to the coordination device 110. The coordination device 110 may then provide, through the website or other notification method, the picture of the delivered advertisement product to the sponsor and/or event operator as evidence of the placed advertisement according to the desired specifications. The coordination device 110 may store the feedback content (e.g., image and/or other details of the advertisement) in association with the event. For example, the mobile upload of the advertisement may be recorded in a Sponsor List section of the associated Event Page.

In an alternative embodiment, the event device 130 and/or fulfillment device 140 may coordinate through the coordination device 110 in order to provide electronic delivery of a selected advertisement. For example, the advertisement product delivered by the advertisement supplier may include an electronic screen configured to display a selected advertisement. The event device 130 and/or the fulfillment device 140 may include the electronic screen and the content may be delivered to the screen for display. The content may be submitted and approved in a manner similar to the methods described herein. In one particular example, the advertisement product may be a portable restroom having electronic screens on an outside and/or inside thereof.

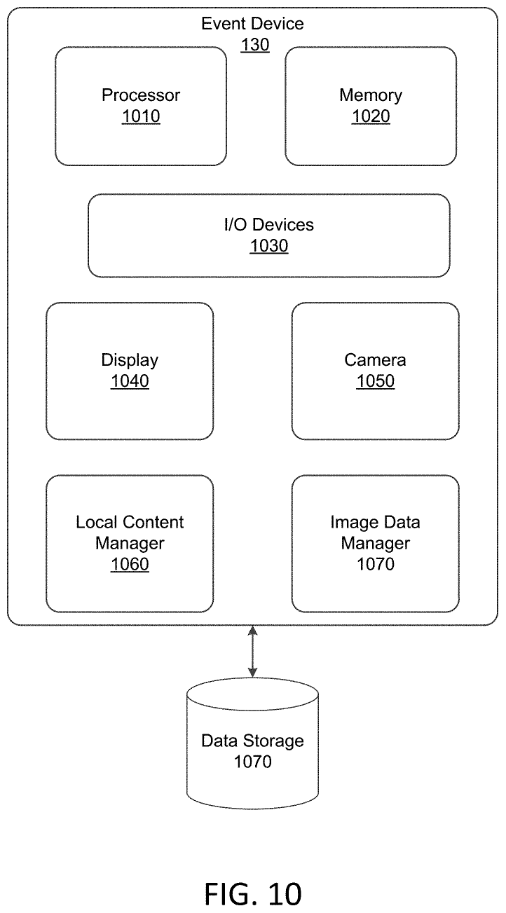

FIG. 10 is an example embodiment of an event device 130 that may be associated with the embodiment described above in which advertisements are electronically delivered (e.g., in the form of changing playlists) to electronic video screens. In an embodiment, the event device 130 may be associated with a portable restroom, such as an electronic billboard mounted to the top of a portable restroom trailer.

The event device 130 includes a processor 1010, memory 1020, one or more I/O devices 1030, a display 1040, a camera 1050, a local content manager 1060, an image data manager 1070, and a data storage device 1080. The processor 1010 and memory 1020 may be specifically configured to implement the disclosed processes. The I/O device 1030 may include, for example, communication components which enable the event device 130 to send and receive data to and from other components of the advertising system 100.

The display 1040 may be an electronic video display, such as a television, monitor, projector, media player, etc. The display 1040 may be configured to display an advertisement, such as a digital advertisement received from the coordination device 110, fulfillment device 140, or sponsor device 150. In one example, the advertisement supply module 250 delivers a playlist of electronic advertisements to the local content manager 1060 for display via the display 1040. The advertisements may include, for example, images and/or videos.

The camera 1050 may be an image collection device in an embodiment. In another embodiment, the camera 1050 may be an internet-connected sensor that measures cell phone signals (Bluetooth, Wi-Fi, and cellular data activity) or motion sensor. The camera 1050 may be configured to collect audience data and provide the audience data to the image data manager 1070. For example, the camera 1050 may collect image data associated with people that are able to view the display 1040, including individuals in vehicles (e.g., in a billboard/road environment).

The local content manager 1060 and image data manager 1070 may be implemented in hardware or software. For example, the local content manager 1060 and image data manager 1070 may include software instructions which are stored in the memory 1020 or in their own hardware component and which are executed by the processor 1010 in order to carry out an associated process. The local content manager 1040 and image data manager 1050 are examples of control modules that may be implemented in the event device 130, with additional and/or alternative control modules possible.

The local content manager 1060 may communicate with other control modules and/or devices in the advertising system 100 to receive media content, such as digital advertisements to be presented via display 1040. The media content may be stored in the data storage device 1080. For example, the local content manager 1060 may communicate with the advertisement supply module 250 to receive media content. In some embodiments, the local content manager 1060 may receive instructions for displaying media content (e.g., from the advertisement supply module 250). For example, the local content manager 1060 may receive instructions from the advertisement supply module 250 for when to display, change, remove, etc. media content (e.g., a timeslot for an advertisement on the display 1040).

The image data manager 1070 may communicate with the camera 1050 to control a flow and use of image data collected by the camera 1050. For example, the image data manager 1050 may receive image data from the camera 1050. The image data manager 1050 may be configured to analyze the image data and make one or more determinations regarding the image data content (e.g., an evaluation of the people and/or objects in the images). In other embodiments, the image data manager 1070 may provide the image data to another component, such as the local content manager 1060 and/or advertisement supply module 250. For example, the image data manager 1050 may provide a real-time stream of image data captured by the camera 1050 to the local content manager 1060 to allow the local content manager to use the image data to make decisions regarding media content to present via the display 1040.

In some embodiments, the image data manager 1070 (or another component of the advertising system 100 that receives image data) is configured to perform data recognition, such as facial recognition or object recognition to determine the presence of individuals or other objects in the image data. In this way, the advertising system 100 may be able to determine an approximate number of “views” of an advertisement (e.g., by determining the number of people that pass by and/or look at the display 1040, the number of vehicles that drive by the display 1040, etc. The advertising system 100 may be further configured to perform analytics to determine demographics information using recognition software that analyzes the image data to determine information about the people that pass by and/or look at the display 1040.

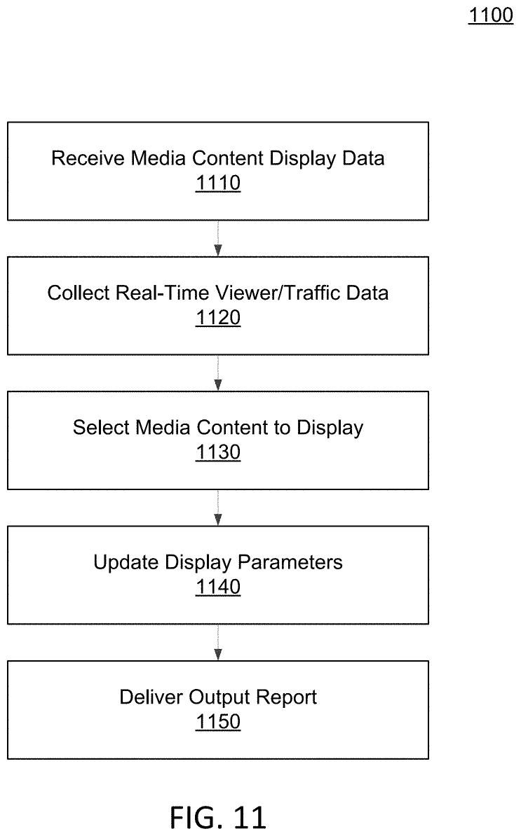

FIG. 11 is a flowchart of an exemplary process 1100 for selectively displaying media content via a display 1040 of an event device 130, consistent with disclosed embodiments. The event device 130 may be associated with an event, such as a festival, concert, sporting event, construction site, multicultural event, or health and fitness event, etc. In an exemplary embodiment, the event is an outdoor event that will include portable restrooms with electronic displays mounted thereon or therein, however, all embodiments are not limited to these events.

The event device 130 may perform one or more steps of the process 1100, but the embodiments are not so limited. Other components of the advertising system 100 may perform one or more steps of any of the disclosed processes, including the process 1100.

In step 1110, the local content manager 1060 may receive media content display data. The media content display data may include media content, which may include a plurality of selectable media, such as digital advertisements (in the form of still images or videos). The plurality of selectable media may be stored in the data storage device 1070. The media content display data may also include display parameters, which may include rules for when to display certain media. In one example, the rules may include instructions on when to present certain media content based on image data obtained by the camera 1050. For instance, a sponsor may obtain a “budget” (also may be considered a “quota”) for an advertisement to be displayed via event device 130. The budget may include a number of views of an advertisement associated with an amount the sponsor has paid (e.g., to an event coordinator). The rules may also define who (e.g., details about the people) should be shown the media content.

In step 1120, the local content manager 1060 may collect real-time viewer/traffic data. For example, the camera 1050 may capture image data associated with people and/or vehicles that come within sightlines of the display 1040. The image data manager 1070 may receive the real-time stream of image data from the camera 1050 and communicate with the local content manager 1060. The image data manager 1070 (and/or the local content manager 1060) may perform an image analytics process to determine an image content parameter. The image content parameter may identify information about what has been captured by the camera 1050. For example, the image content parameter may be a count of a number of people that pass and/or view the display 1040. In another example, the image content parameter may be demographic or other descriptive information of the individuals in the images, such as age, gender, ethnicity, height, clothing, style, etc., as determined by facial or object recognition software associated with the advertisement system 100 (e.g., as part of the image data manager 1070).

In step 1130, the local content manager 1060 may select media content to present via the display 1040, based on the display parameters and the image content parameters. For example, the local content manager 1060 may display an advertisement based on an individual within viewing range of the display 1040. The presence of the individual may trigger the display and/or demographic or descriptive information associated with the individual may trigger a particular advertisement. In some embodiments, the local content manager 1060 may select an advertisement based on a count of people (or types of people) or vehicles that pass by or look at the display 1040. In another example, the local content manager may select an advertisement based on weather information, lighting, presence of a threshold number of people or objects or types of people or objects, presence of a specific person or object, or other information that can be determined based on image data captured by the camera 1050.

In step 1140, the local content manager 1060 may update display parameters. For example, the local content manager 1060 may keep track of the number of views of a selected media content element. In this way, the local content manager 1060 may keep track of an established budget for a particular advertisement (e.g., once 100 people have seen or passed by a displayed advertisement, the advertisement is changed). In step 1150, the local content manager 1060 may create and deliver an output report (e.g., to the coordinate device 110). The output report may include details about media content displayed, including duration, changes, etc. The output report may also include information from the image data, such as number of views of media content, how many times it was seen by each person, and for how long (impressions, frequency, and dwell time), as well as demographics and/or other descriptive information.

Additional embodiments of the advertising system 100 may include accounting tools that allow payment exchanges among and between the different users (e.g., advertisement suppliers, event operators, sponsors, and an entity that maintains the advertisement system 100). Each user profile may include an associated account and/or account balance. At various steps of the disclosed processes, the coordination device 110 may debit and credit certain accounts. For example, after a sponsor has made a selection at the advertisement selection tool, an amount may be deducted from their account balance and amounts added to account balances associated with an associated event operator and/or advertisement supplier. In some embodiments, the coordination device 110 may track credits and/or discounts, such as referral credits based on invites sent by event operators or advertisement suppliers, and apply these credits and/or discounts when transferring funds between account balances.

The present disclosure describes an advertising system that provides an all-in-one platform for event marketing. The advertising system performs data transformation to create interactive user interfaces that are specifically tailored to connecting different parties involved in placing an advertisement at events. The system allows each type of user to view relevant information in a convenient form, such as through the advertisement selection tool and customization tool described herein. The advertising system uses a login module to organize and control the information that is available to the different types of users.

For example, advertisement suppliers, such as portable restroom operators, are able to view a list of events and coordinate with event operators to establish base product (e.g., portable restroom) contracts. The advertisement suppliers may also have access to an invite system to contact potential event operators and/or sponsors and invite them to take part in the process, such as by registering their event and/or sponsoring with an advertisement. The advertisement suppliers also have access to sponsor information and product specifications. In some embodiments, advertisement suppliers may also be able to register events, such as events that they currently or will service.

In another example, event operators have access to create an event page and provide information sufficient to create an advertisement selection tool, including product locations for advertisements. The event operators also receive sponsor applications and have tools to approve or deny the applications. The event operators thus have control over the advertisements that are being placed at their events.

In yet another example, sponsors have access to view available events. These events can be searched, sorted, and filtered based on event name, locations, event date(s), region of the country, attendance, and attendee demographics. After selecting an event, the sponsor can submit an event proposal by uploading or selecting content and submitting the proposal to the event operator. After content is approved, the sponsor can use an advertisement selection tool in order to view and select specific locations for their advertisements. The sponsor, in some embodiments, may also have access to the list of sponsors already accepted for the event, thereby allowing the sponsor to make decisions regarding advertisement placement with respect to other advertisers. The sponsor may be provided with lists of submitted applications, approved applications, and denied applications.

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

The system and processes of the figures are not exclusive. Other systems, processes and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A computer-implemented method for coordinating advertisement placements at an event, comprising:
receiving event information related to a future event;
creating, by a processing device, an event page based on the future event, the event page including a plurality of advertisement opportunities at the event;
generating, by the processing device, an advertisement selection tool, the advertisement selection tool being an interactive interface for a user to select one of the advertisement opportunities.
receiving a selection of one of the advertisement opportunities through the advertisement selection tool;
receiving one or more product specifications associated with the selection; and
providing, by the processing device, the one or more product specifications to a fulfillment device for delivery of a product having an advertisement according to the one or more product specifications at the future event.

2. The computer-implemented method of claim 1, wherein the event information includes information identifying the event, including date of the event and location of the event.

3. The computer-implemented method of claim 2, wherein the event information further includes a site map of the future event.

4. The computer-implemented method of claim 3, wherein the advertisement selection tool includes locations for advertisement opportunities based on the site map.

5. The computer-implemented method of claim 1, wherein the future event is an outdoor event.

6. The computer-implemented method of claim 5, wherein the outdoor event is a festival, concert, sporting event, construction site, multicultural event, or health and fitness event.

7. The computer-implemented method of claim 5, wherein the product is a portable restroom.

8. The computer-implemented method of claim 1, further comprising providing the product specifications to a client device associated with an event operator for approval.

9. The computer-implemented method of claim 8, wherein the product specification includes sponsor information and advertisement information.

10. An advertisement system for coordinating advertisements at an event, the system comprising:
a processing device configured to execute instructions stored in a memory device;
a coordination device configured to communicate, via the processing device, with a client device to provide a user interface to the client device, the coordination device comprising:
a login module configured to create, via the processing device, and store user profiles associated with a plurality of users;
a sponsor module configured to provide a customization tool to the client device for receiving advertisement details from a user;
an event coordination module configured to create, via the processing device, an advertisement selection tool based on information associated with an event and provide the advertisement selection tool to the client device; and
an advertisement supply module configured to coordinate, via the processing device, delivery of an advertisement based on the advertisement details and a selection received through the advertisement selection tool.

11. The advertisement system of claim 10, wherein the login module is configured to create and store different types of user profiles.

12. The advertisement system of claim 11, wherein the different types of user profiles include an event operator profile, an advertisement supplier profile, and a sponsor profile.

13. The advertisement system of claim 12, wherein the coordination device is configured to customize the user interface provided to the client device based on the type of user profile associated with the user device.

14. The advertisement system of claim 10, wherein the sponsor module is configured to receive an event proposal through the customization tool and submit the event proposal to an event device for approval.

15. The advertisement system of claim 14, wherein the event proposal includes the content of a proposed advertisement.

16. The advertisement system of claim 10, wherein the sponsor module is further configured to provide a list of available events to a user.

17. The advertisement system of claim 16, wherein the list of available events is filtered by the sponsor module based on advertisement parameters provided by an event operator user and sponsor details.

18. The advertisement system of claim 10, wherein the event coordination module is configured to generate the advertisement selection tool based on a site map associated with the event and details of advertisement locations.

19. The advertisement selection tool of claim 18, wherein the details of the advertisement locations includes locations of portable restrooms.

20. The advertisement selection tool of claim 10, wherein the selection received through the advertisement selection tool includes a location of an advertisement.
